(19) United States
(12) Patent Application Publication
(10) Pub. No.: US 2025/0269597 A1
(43) Pub. Date: Aug. 28, 2025

(54) ELECTROMAGNETIC SENSITIVE EPOXY/RESIN SYSTEM FOR ADDITIVE MANUFACTURING APPLICATIONS

(71) Applicant: KING FAHD UNIVERSITY OF PETROLEUM AND MINERALS, Dhahran (SA)

(72) Inventors: Suhail Hyder VATTATHURVALAPPIL, Dhahran (SA); Rajesh THERAVALAPPIL, Dhahran (SA); Usman ALI, Dhahran (SA)

(73) Assignee: KING FAHD UNIVERSITY OF PETROLEUM AND MINERALS, Dhahran (SA)

(21) Appl. No.: 18/980,793

(22) Filed: Dec. 13, 2024

Related U.S. Application Data
(60) Provisional application No. 63/558,381, filed on Feb. 27, 2024.

(51) Int. Cl. B29C 64/291; B29C 64/314; B29K 63/00; B29K 105/16; B29K 505/12; B33Y 10/00; B33Y 30/00

(52) U.S. Cl. CPC B29C 64/291; B29C 64/314; B29K 2063/00; B29K 2105/162; B29K 2505/12; B29K 2995/0008; B33Y 10/00; B33Y 30/00

(57) ABSTRACT

A method, material composition and apparatus for forming a three-dimensional structure using single part epoxy resins via electromagnetic induction heating. The method includes making a base matrix phase containing an epoxy resin and a latent curing agent with magneto-sensitive particles to obtain an electromagnetic (EM) phase. The mixture is transferred to a molding vessel having an electromagnetic induction heater positioned a first distance away from a top surface of the EM resin system and cured with the electromagnetic induction heater to form a three-dimensional structure.

### CROSS REFERENCE TO RELATED APPLICATION

The present application claims benefit of priority to U.S. Provisional Application No. 63/558,381 having a filing date of Feb. 27, 2024 which is incorporated herein by reference in its entirety.

### BACKGROUND OF THE INVENTION

### Field of the Invention

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

The exceptional chemical resistance, dimensional stability, and strength of epoxy-based polymers, even at elevated temperatures, make epoxy-based polymers, also referred as epoxy polymers, applicable to numerous industries, such as energy, aerospace, automotive, and marine. Epoxy polymers are preferred over thermoplastics on account of their robust covalent and crosslinking functionalities, which lead to superior mechanical properties and dimensional stability. In addition, their influence on future developments in lightweight and energy-efficient buildings will be crucial.

The utilization of additive manufacturing techniques, such as stereolithography (SLA), digital light processing (DLP), and liquid crystal display (LCD), has significantly impacted and revolutionized several industrial sectors. These technologies have enabled the efficient and precise production of high-value products, meeting demand as needed. SLA has prompted several efforts to improve and perfect 3D printers that are especially tailored for epoxy-based polymers and composites. It has not only resulted in the advancement of DLP and LCD, but it has also led to the creation of additional techniques that improve resolution and material quality. Nevertheless, SLA has several unresolved problems. The following items are included: 1) Printing arrangements; 2) Costly laser systems 3) slow printing speed; and 4) limitations in resin viscosity. Consequently, there is an increased demand for intelligent and eco-friendly methods to efficiently and inexpensively produce thermoset-based components for high-strength structural applications that require enhanced dimensional stability at elevated temperatures.

Accordingly, it is one object of the present disclosure to provide methods and systems to be used as a feeding material for additive manufacturing equipment that works under the electromagnetic induction (EM) principle. Unlike the conventional methodologies of using ovens and room temperature curing, the technique in the present disclosure facilitates rapid curing regardless of the size of the resin system or the oven to keep the resin infused parts. The epoxy system of the present disclosure, also referred to as a resin system, consists of a rapid single-component epoxy system mixed with conductive and/or magnetosensitive particles. Conductive or magnetosensitive nanoparticles under exposure to EM radiation generate heat due to the joules effect and hysteresis losses. This heat leads to the formation of free radicals in the epoxy system, which act as catalysts for the curing and crosslinking of the resin, causing it to solidify. The EM heating rate can be regulated by controlling EM parameters such as current, frequency, and power. It also depends on the number of conductive particles dispersed in the resin system. The resin system differs from typical UV-sensitive and other types of resins in that it retains its efficacy regardless of ambient light or temperature. The curing process preferably commences over a predetermined temperature. This technology has the capacity to revolutionize the composite manufacturing sector by reducing production expenses, decreasing lead times and with its potential to manufacture larger parts. Furthermore, the electromagnetic heating system utilized as the curing source in this method is more economically efficient when compared to its UV-based laser counterpart in stereolithography.

Accordingly, in one aspect the present disclosure provides a method and apparatus for forming a molded structure from an epoxy mixture containing magnetically sensitive nanoparticles functionalized for efficient dispersal in the epoxy resin.

### SUMMARY OF THE INVENTION

In an exemplary embodiment of a method of forming a three-dimensional structure, comprises introducing a base matrix phase in a first preparation vessel, wherein the base matrix phase comprises of an epoxy resin and a latent curing agent; mixing and uniformly dispersing magneto-sensitive particles in a second preparation vessel to obtain an EM phase, wherein the magneto-sensitive particles treated by a chemical functionalization; transferring the EM phase in to the first preparation vessel and mixing the EM phase and the base matrix phase to obtain an electromagnetic (EM) sensitive resin system; transferring the EM resin system to a molding vessel having an electromagnetic induction heater positioned a first distance away from a top surface of the EM resin system; and curing the electromagnetic-sensitive resin system in the molding vessel with the electromagnetic induction heater to form the three-dimensional structure.

In another exemplary embodiment, the latent curing agent is a dicyandiamide and the magneto-sensitive particles are Fe₃O₄.

In yet another embodiment, the base matrix phase system further comprises an accelerator, wherein the accelerator is selected from the group consisting of a cycloaliphatic-bis-urea, a 4,4-methylene-bis-urea, a N,N′-dimethylurea, a 2,4′ Toluene bis dimethyl-urea, and a 3-(3,4-dichloro-phenyl)-1,1-dimethyl-urea.

In an embodiment, the curing is performed with a vacuum bagging technique.

In another embodiment, the chemical functionalization includes a chemical agent selected from the group consisting of oleic acid and carboxymethylcellulose.

In an exemplary embodiment, the EM resin system is a single-part resin system and is free of a resin hardener.

In another embodiment, an additive manufacturing apparatus for a single part electromagnetic resin system comprises a molding pan configured to hold the single part electromagnetic resin system; and an electromagnetic induction heater configured to position an electromagnetic induction coil above the molding pan.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic diagram of an exemplary embodiment of the epoxy system mixed with magneto sensitive/conductive nanoparticles, according to certain embodiments.

FIG. 2 illustrates an exemplary configuration for curing an epoxy system, according to certain embodiments.

FIG. 3 illustrates an exemplary time-temperature relationship of an epoxy system with an electromagnetic induction system, according to certain embodiments.

FIG. 4 illustrates an exemplary chemical formulation for electromagnetic sensitive resin, according to certain embodiments.

### DETAILED DESCRIPTION OF THE PREFERRED EMBODIMENTS

In the drawings, reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to a system and method for a chemical composition for the EM-sensitive resin together with the experimental procedures aimed at demonstrating the idea and validating the related claims.

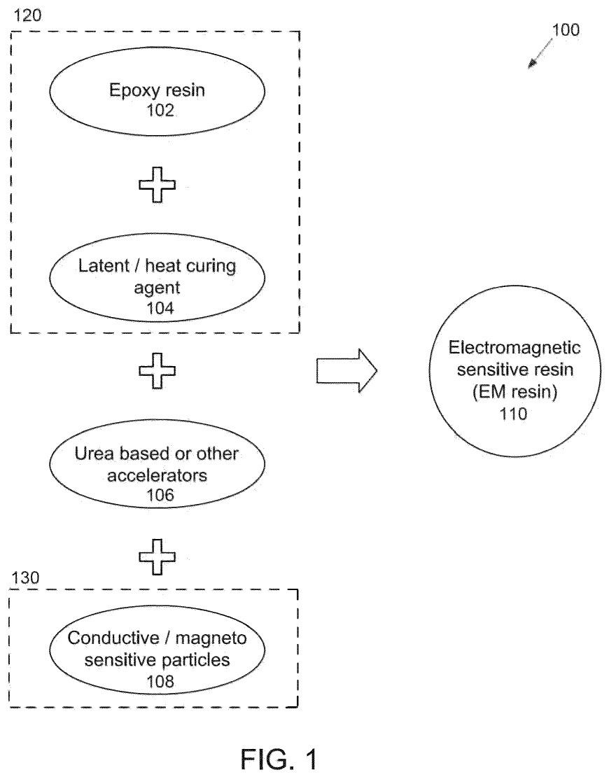

Referring to FIG. 1, a resin system of the present disclosure comprises an electromagnetic sensitive resin (EM resin) 100 that works under electromagnetic induction heating. In certain embodiments, the EM resin 100 comprises an epoxy resin 102, a latent curing agent 104, accelerators 106, and conductive/magneto-sensitive particles 108. In another embodiments, the EM resin 100 comprises two phases: a) a base matrix phase 120 comprises an epoxy resin 102 combined with a latent curing agent 104 with an optional accelerator 106; and b) an EM phase 130 comprises conductive/magneto-sensitive particles 108. The first phase may be. In some embodiments, the epoxy resin 102 may be a 105 epoxy resin from West System Ltd. and the latent curing agent 104 may be a dicyandiamide. In some embodiments, a curing process of the latent curing agent 104 may be activated by thermal energy.

In certain embodiments, conductive/magneto-sensitive particles 108 may be added to the base matrix phase 120 to facilitate interaction with the electromagnetic induction waves.

The conductive/magneto-sensitive particles 108 may be nanoparticles with conductive properties, ferromagnetic nanoparticles with a high Curie temperature such as Fe₃O₄. Preferably the conductive/magneto-sensitive particles are particles of magnetite (Fe₃O₄) having a particle size of 50 to 100 nm. One or more additional magneto-sensitive particles of various sizes, ranging from microns to millimeters, may be included. Additional magneto-sensitive particles include particle of cobalt, nickel, silver, and gold can all be selected as magneto-sensitive particles. When using various sizes and materials of magneto-sensitive particles.

In a preferred embodiment of the present disclosure the magneto-sensitive particles are iron oxide nanoparticles that have been functionalized for compatibility with the epoxy matrix. The iron oxide nanoparticles preferably have an average particle size within range of 5-500 nm, preferably 10-400 nm, 25-300 nm, or 50-100 nm. The iron oxide nanoparticles preferably have a narrow particle size distribution with at least 95%, preferably at least 97% or 99%, of the nanoparticles having a particle size that is +10% or +5% of the median particle size of the iron oxide nanoparticle.

The iron oxide nanoparticles are preferably coated with an organic material containing polar groups. In a preferable embodiment, the coating is a polyvinyl alcohol (PVA) polymer. Iron oxide nanoparticles are first coated with the polyvinyl alcohol polymer. Preferably the iron oxide particles are fully coated with the poly vinyl alcohol polymer such that no iron oxide surface is uncovered and/or directly exposed. The resultant particle has an iron oxide core surrounded by a polyvinyl alcohol polymer shell. The relative amounts of material on a mass basis of iron oxide to poly vinyl alcohol polymer ranges from 1:1 to 1:25, preferably 1:2 to 1:20, 1:3 to 1:15, or 1:5 to 1:10.

Preferably, the polyvinyl alcohol polymer shell is functionalized with an acetylation agent, such as chloroacetic anhydride, an acyl chloride, an isothiocyanate and/or a ketene.

Functionalization of the polyvinyl alcohol shell further compatibilizes the iron oxide nanoparticle with the epoxy matrix. Compatibilization functions to better disperse the iron oxide nanoparticles within the epoxy matrix while concurrently keeping individual iron oxide particles separate from one another.

In a preferable embodiment a second magneto-sensitive particle is present in the EM resin system that is subject to the electromagnetic field. The second magneto-sensitive particle includes a metal that is different from the first magneto-sensitive particle (e.g., Fe₃O₄) that is dispersed homogeneously throughout the EM resin system undergoing exposure to the electromagnetic induction field. Unlike the first magneto-sensitive particles, that are preferably coated with PVA and compatibilized with a polar group, the second magneto-sensitive particle is preferably in the form of elemental metal that is not compatibilized or coated with any polymer other than the polymer present in any matrix that is undergoing exposure to electromagnetic radiation. The second magneto-sensitive particle functions as a diamagnetic component to help dispersion of the first magneto-sensitive particles within the EM resin system undergoing exposure to electromagnetic radiation. The second magneto-sensitive particles may be dispersed homogeneously throughout the EM resin system or may be biased to one or more sides. For example, a majority, preferably 70% or more or 80% or more by weight of the total weight of the second magneto-sensitive particle may be homogeneously dispersed within a lowermost volume of the article or composition undergoing exposure to electromagnetic radiation. Preferably, a bottom layer of the EM resin system contains the entire amount of the second magneto-sensitive material, this volume preferably representing up to 10%, up to 20%, or up to 25% of the total volume of the EM resin system undergoing exposure to electromagnetic radiation. Preferably the second magneto-sensitive material is homogeneously dispersed in a bottom layer representing 10 vol % or less of the total volume of the EM resin system undergoing exposure to electromagnetic radiation. The presence of the second magneto-sensitive material, restricted to a bottom layer, provides a magnetic damping or magnetic alignment effect that may yield a more even and homogeneous electromagnetic exposure to the first magneto-sensitive particles distributed throughout the EM resin system.

In certain embodiments, the base matrix phase 120 and the EM phase 130 are combined to form a single-part electromagnetic induction sensitive epoxy system. In an exemplary embodiment, the EM resin system 100 comprises 100 parts of the epoxy resin 102, 5-10 parts of the latent curing agent 104, and 10-20 parts of the conductive/magneto-sensitive particles 108. The latent curing agents 104 may be in powdered or crystalline form.

The base matrix phase 120 may be prepared by first introducing the latent curing agents 104 into a suitable solvent, such as 2-methoxyethanol or acetone, to evenly distribute the latent curing agent 104 throughout the epoxy resin 102. The solvent may be selected to ensure its effective removal from the epoxy resin after mixing. The accelerators 106, such as cycloaliphatic-bis-urea, 4,4-methylene-bis-urea, N,N′-dimethylurea, 2,4′-toluene bis-dimethyl urea (Cycure-8020), 3-(3,4-dichloro-phenyl)-1,1-dimethyl urea, or any other similar accelerators, may be added to augment the curing process and thereby reducing the curing time.

The EM phase 130 may be prepared by processing conductive/magneto-sensitive particles 108 with a chemical functionalization to improve their dispersion and even distribution of heat throughout the EM resin system 100. Chemical agents such as oleic acid, carboxymethylcellulose, and other surface functionalization may be employed to effectively disperse conductive/magneto-sensitive particles 108. Preferably the oleic acid and/or carboxymethylcellulose are present in an amount that is within 10%, preferably within 5% of the amount by mass of the magneto-sensitive particles. Subsequently, the EM phase 130 may be introduced into the base matrix phase 120 to obtain the EM resin 110. The resultant mixture is preferably sonicated to provide effective dispersion of the EM phase in the base matrix phase.

In certain embodiments, the base matrix phase 120 and the EM phase 130 may be prepared in a resin holder that is not made of metal to mitigate the thermal effects caused by electromagnetic radiation on the resin holder. A glass pan that allows electromagnetic waves to pass through may be used to prepare the base matrix phase 120 and the EM phase 130 that is sensitive to electromagnetic radiation.

In certain embodiments, the EM resin system 100 may be utilized as feeding material to any electromagnetic induction based 3D printers or additive manufacturing equipment. As disclosed previously, the EM resin system 100 may be a single-part epoxy system only subject to heat energy once placed on a print bed of the 3D printer. In another embodiments, the EM resin system 100 may be utilized in composite manufacturing technologies such as a vacuum bagging, non-metallic pipe extrusion, curing of plastics using vacuum assisted resin transfer molding, filament winding, automated fiber placement, or any other suitable techniques. Electromagnetic induction-based 3D printers have the advantage of being able to build larger objects in a relatively quicker amount of time compared to stereolithography. Larger objects be made with bigger electromagnetic coils or by incorporating them into a mobile robotic arm, thereby enabling enhanced productivity and adaptability in the production process.

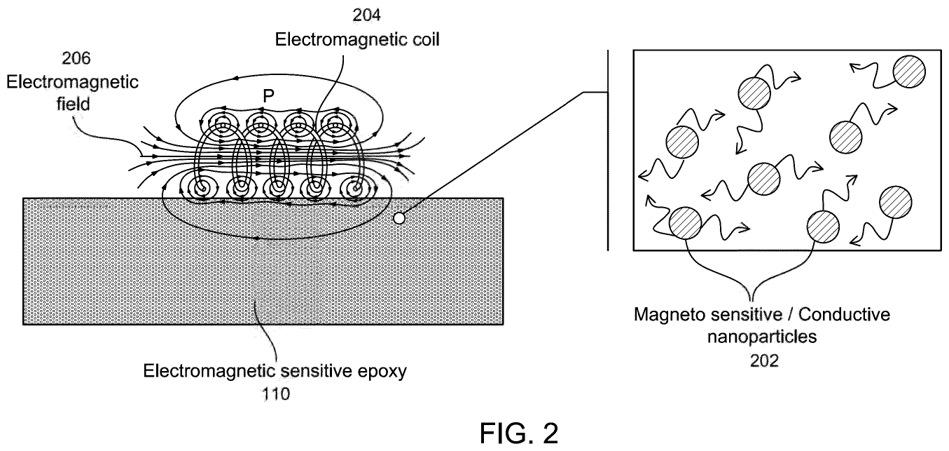

Turning to FIG. 2, the EM resin 110 may be heated by an electromagnetic coil 204 which facilitates electromagnetic induction (EMI) heating. The electromagnetic coil 204 may produce electromagnetic field 206, such as an alternating magnetic field preferably with a frequency beyond 150 KHz to effectively heat the magneto-sensitive particles in nanoscale geometries. The frequency and power required for the heating of magneto-sensitive particles are dependent on the size and electromagnetic sensitivity of the chosen particles. The electromagnetic field promotes heating of conductive/magneto-sensitive particles 202. In some embodiments, the EM resin system 100 consists of the EM resin 110 and may be free of hardeners. In another embodiments, the curing process of the EM resin system 100 may be initiated by chemical agents.

In some embodiments, the EM resin system 100 may have a shelf life of six months or higher depending on the curing agents 104 and accelerators 106.

The form and complexity of the final product may depend on several factors including the dispersity and size of conductive/magneto-sensitive particles 108, electromagnetic wave focusing, power, frequency, and amperes of the current, as well as the types of coils used for heating purposes.

In certain embodiments the curing time or manufacturing time of the finished product may be controlled by selecting desired chemical formulations in the EM resin system 100 and properties of the electromagnetic induction heater such as power, frequency, type and shape of the coil of the electromagnetic induction heater as well as concentration of conductive/magneto-sensitive particles 108.

### Example

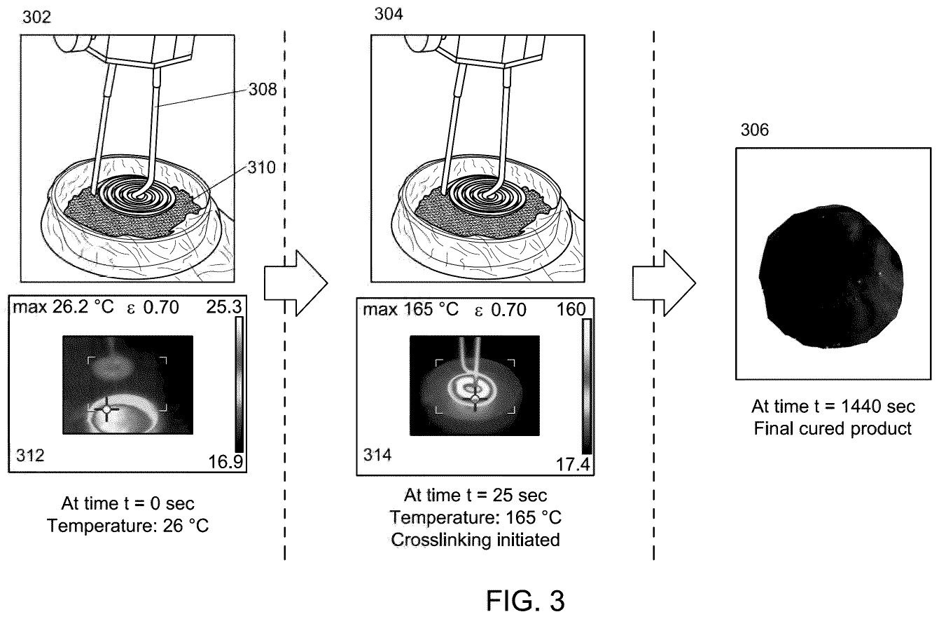

FIG. 3 illustrates an exemplary procedure of curing the EM resin system 100. The procedure utilizes two components: a) an electromagnetic induction heater 308 and b) a glass pan filled with a resin system 310 that is sensitive to electromagnetic waves. The curing procedure was monitored by an infrared camera to track the temperature of the resin system 310.

The heating source employed is a 1000 W magnetic induction heater 308 that operates at either 110 V or 220 V. The induction heater 308 is connected to a pan-shaped electromagnetic coil. Any conductive substance placed in the vicinity of the coil gets heated up due to the joule effect and hysteresis losses. The pan-type coil was positioned 5 mm away from the epoxy system 310.

The epoxy system 310 comprises 100 parts epoxy resin, 5-8 parts dicyandiamide, and twenty percent by weight of ferromagnetic nanoparticles. Ferromagnetic nanoparticles possess both magnetosensitivity and conductivity. The nanoparticles were sonicated to ensure even dispersion inside the epoxy system, ensuring uniform heat distribution across the epoxy medium. To prevent heating of the epoxy holder from EM radiations, an EM transparent glass pan was selected to fill the EM sensitive resin system.

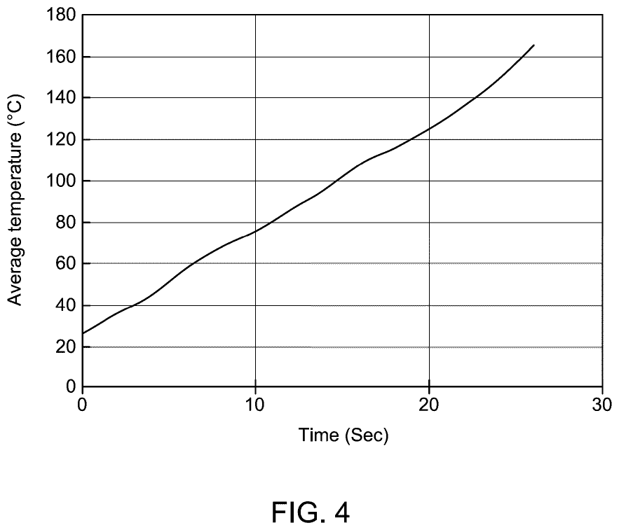

An infrared thermal camera is employed to photograph and monitor the heating procedure of the resin system. At step 302, the temperature of the resin system 310 was recorded as 26° C. at time t=0 s as shown in the infrared picture 312. At step 304, the temperature of the resin system 310 was recorded as 165° C. at time t=25 s as shown in the infrared picture 314. At step 306, the epoxy system 310 exposed to electromagnetic radiation underwent full curing in under 5 minutes. As shown in FIG. 4, the correlation between time and temperature in the EM epoxy system 100 indicates a rapid rise in temperature from to 26° C. to 165° C. over a time span of 25 seconds.

Numerous modifications and variations of the present disclosure are possible in light of the above teachings. It is therefore to be understood that within the scope of the appended claims, the invention may be practiced otherwise than as specifically described herein.

1. A method of forming a three-dimensional structure, comprising:
introducing a base matrix phase in a first preparation vessel, wherein the base matrix phase comprises an epoxy resin and a latent curing agent;
mixing and uniformly dispersing first magneto-sensitive particles in a second preparation vessel to obtain an EM phase,;
mixing the EM phase with the base matrix phase to obtain an electromagnetic (EM) resin system;
transferring the EM resin system to a molding vessel having an electromagnetic induction heater positioned a first distance away from a top surface of the molding vessel; and
exposing the electromagnetic resin system in the molding vessel to electromagnetic radiation to heat and cure the electromagnetic resin system and thereby form the three-dimensional structure.

2. The method of claim 1, wherein the latent curing agent is a dicyandiamide and the first magneto-sensitive particles are Fe₃O₄.

3. The method of claim 1, wherein the first magneto-sensitive particles include an Fe₃O₄ nanoparticle core having an outer surface coated with a polyvinyl alcohol polymer shell.

4. The method of claim 3, where the polyvinyl alcohol polymer shell is functionalized with one or more polar groups.

5. The method of claim 4, where the polyvinyl alcohol polymer shell is functionalized with one or more selected from the group consisting of chloroacetic anhydride, an acyl chloride, an isothiocyanate and/or a ketene.

6. The method of claim 1, wherein the base matrix phase further comprises an accelerator.

7. The method of claim 6, wherein the accelerator is selected from the group consisting of a cycloaliphatic-bis-urea, a 4,4-methylene-bis-urea, a N,N′-dimethylurea, a 2,4′-toluene bis dimethyl urea, and a 3-(3,4-dichloro-phenyl)-1,1-dimethyl urea.

8. The method of claim 1, further comprising placing the molding vessel containing the EM resin system in a vacuum bag, then applying a vacuum to the molding vessel containing the EM resin system.

9. The method of claim 1, wherein the EM resin system comprises a chemical agent selected from the group consisting of oleic acid and carboxymethylcellulose.

10. The method of claim 1, wherein the EM resin system is a single-part resin system and is free of any fiber reinforcements.

11. The method of claim 1, wherein the first magneto-sensitive particles have a core Fe₃O₄ particle size of 50-100 nm and are coated with a polyvinyl alcohol polymer to form a core shell structure that has an outside surface functionalized with one or more selected from the group consisting of a chloroacetic anhydride, an acyl chloride, and an isothiocyanate; and
wherein the EM resin system further comprises second magneto-sensitive particles selected from the group consisting of cobalt, nickel, silver, and gold;
wherein the second magneto-sensitive particles are present in a first magneto-sensitive particles: second magneto-sensitive particles mass ratio of 1:0.05 to 1:0.5, and
wherein the second magneto-sensitive particles are dispersed in a bottom layer of the EM resin system that is 10% by volume or less of the total volume of the EM resin system.

12. An electromagnetic (EM) resin additive manufacturing system, comprising:
a molding pan configured to hold an electromagnetic (EM) resin system; and
an electromagnetic induction heater configured to position an electromagnetic induction coil above the molding pan,
wherein the electromagnetic induction coil is a flattened coil have a bottom surface presenting a plane that is co-planar and axially with the molding pan which has a circular bottom and a circumferential upwardly extending edge; and
wherein the electromagnetic resin system comprises first magneto-sensitive particles having a core Fe₃O₄ particle size of 50-100 nm coated with a polyvinyl alcohol polymer to form a core shell structure having an outside surface functionalized with one or more selected from the group consisting of a chloroacetic anhydride, an acyl chloride, and an isothiocyanate; and
wherein the EM resin system further comprises second magneto-sensitive particles selected from the group consisting of cobalt, nickel, silver, and gold;
wherein the second magneto-sensitive particles are present in a first magneto-sensitive particles: second magneto-sensitive particles mass ratio of 1:0.05 to 1:0.5, and
wherein the second magneto-sensitive particles are dispersed in a bottom layer of the EM resin system that is 10% by volume or less of the total volume of the EM resin system, wherein the bottom layer rests on the molding pan.
